(19) United States
(12) Patent Application Publication
(10) Pub. No.: US 2008/0121287 A1
(43) Pub. Date: May 29, 2008

(54) Liquid level control valve

(76) Inventor: David Gordon Arthur Crichton, Rodney (NZ)

Correspondence Address: YOUNG & THOMPSON, 209 Madison Street, Suite 500, ALEXANDRIA, VA, 22314, US

(21) Appl. No.: 11/604,204

(22) Filed: Nov. 27, 2006

(51) Int. Cl. F16K 31/18

(52) U.S. Cl. 137/414

(57) ABSTRACT

A valve for controlling a “guaranteed” back up pressurised liquid supply to a tank fed from another primary supply. The valve controls the quantity of water in the tank between a predetermined upper and lower level. The valve has an inlet and an outlet interconnected by a restricted passage controlled by a diaphragm. The passage is formed by a bore and a reciprocally operative rod is mounted therein. The rod is connected to a support lever which is spring biased to close the valve. The support lever has an operating weight element suspended therefrom by a depending cord. The operating weight has two sections, which have a combined weight providing substantially neutral buoyancy in water. The cord length between the lever and the lower operating weight sections determines the lower water level threshold. The cord length between the two weight sections determines the differential between the lower and upper level.

This invention relates to liquid control valves and in particular a valve suitable for use in controlling a pressurised supply of liquid to a reservoir tank or similar storage means. More particularly the invention relates to a liquid supply valve which will open and close respectively when the quantity of liquid within a tank lowers beyond a predetermined lower level threshold and close when the water level reaches a predetermined upper level.

### BACKGROUND OF THE INVENTION

Various apparatus are known to control pressurised liquid supplies to a tank or reservoir for temporary or intermediate stage storage of a quantity of the liquid. Typically, a controllable outlet is included in the tank or reservoir enabling “draw-off” from the tank when required. Such tanks are put to many industrial, domestic and farming or agricultural uses to contain a wide variety of liquids. In some applications more than one liquid supply, of the same or different liquids, may be provided to the tank. Often there is a need to match the supply and draw-off of the liquid(s) to and from the tank so that the quantity of liquid being stored at any one time is maintained between required upper and lower volumes. These volumetric levels of course correspond to upper and lower liquid levels within a tank and it is normal that these upper and lower parameters be monitored to achieve the required volumetric control. Such means include electronic devices and associated valve activating circuitry and/or mechanically float-arm operated valves. Particularly in remote areas often the former approach is not suitable owing to the lack of an electrical power source and/or the difficulty in maintaining and servicing a stand alone electrical power source such as a battery. Also float-arm operated valves have limitations as these are biased open and close when the quantity of liquid level reaches a predetermined upper level. Being biased open can led to unacceptable waste should the float-arm and/or the valve itself malfunction and the valve fail to close. A first object of this invention is to provide a pressurised liquid supply control valve suitable for use with liquid storage tanks that requires neither an electrical power source nor a float to monitor and operate to maintain a quantity of a liquid within a tank between predetermined upper and lower limits.

It is envisaged that a main use of the valve will be to control an established and “guaranteed” supply, such as either a reticulated “mains” supply or a pumped supply such as from a bore or creek, to a rainwater collection tank as a back up supply therefor. More particularly, means for the collection and storage of rainwater for use in many applications is well established. Typical cases are domestic dwellings and similar buildings where collected rain water is stored in a tank and is utilised at least for the non-potable outlets, such as laundry, toilets and irrigation requirements, of the dwelling. To avoid the tank running dry valve means are normally provided to control the alternative “guaranteed” or back-up water supply to such a tank to ensure the quantity of water therein is maintained above a predetermined lower level. It is preferable that this function be automatically activated, that is, cutting-in and opening the valve as required at the lower water level threshold. Similarly the valve needs to close when the water level reaches an upper level threshold. For various reasons the differential required between the predetermined upper and lower levels can vary considerably. For example, often this type of tank is utilised in remote areas and in high fire risk areas it may be desirable to maintain a substantial quantity of water thus a minimal differential in levels. In less fire prone areas and/or higher rain fall areas less reliance on the “guaranteed” supply may be made. Thus a lower minimum level and thus a larger differential can be set. Thus it is a further object of this invention to provide a valve wherein the closing an opening thresholds levels may be readily set and altered by unskilled personnel. Yet a further object is to provide the public with a useful choice.

### SUMMARY OF THE INVENTION

According to a first embodiment of this invention there is provided a pressurised liquid supply control valve for a liquid storage tank comprising means to bias the valve to a closed mode and opening means to open the valve to an open mode characterised in that the opening means includes a two section operating weight element that combined have marginally less than neutral buoyancy in the liquid to be stored in the tank, the sections of the operating weight element being connectable individually or in line by a depending element(s) from the opening means such that one section is spaced above the other section and as to become in contact with a quantity of liquid therein, whereby the valve will open when the combined weight of the operating weight element sections results in an opening moment of force on the opening means and will close when the combined weight of the operating weight element sections is substantially supported by the liquid in the tank.

According to a second embodiment of this invention there is provided a pressurised liquid supply control valve as described in the preceding paragraph wherein the valve is adapted to be mounted in situ within an upper section of a liquid storage tank and the length of the connection means between the opening means and the upper weight section of the weight element is selected to determine an upper level for the liquid within the tank and the length of the connection means between the opening means and the lower weight section of the weight element is selected to determine a lower level for the liquid within the tank.

According to a third embodiment of this invention there is provided a pressurised liquid supply control valve to control a pressurised liquid inlet to a tank for storing a quantity of the liquid and having a controllable outlet comprising means to bias the valve to a closed mode and opening means to open the valve to an open mode characterised in that the opening means includes a two section weight element with the sections adapted to be effectively separated one above the other at a distance to provide a required lower liquid level and an upper liquid level within the tank, the weight sections having a combined valve opening effective weight marginally less than that required to provide the weight element with a neutral buoyancy in the liquid; the weight element being connectable to the opening means whereby, in situ, with the valve mounted in an upper section of the tank and with the weight element suspended from the valve opening means into the tank, in a first operational mode the valve will be biased close until the level of liquid lowers to the required lower liquid level, that level being determined when both sections of the weight element become fully supported by the opening means thereby causing the valve to open and, in a second operational mode, upon the level of liquid increasing to the required upper liquid level, being a level at a height spaced above the required lower liquid level that is commensurate to the separation distance between the two weight sections and at which the liquid within the tank substantially supports both sections of the weight element, the biasing can operate to close the valve.

According to a fourth embodiment of this invention there is provided a pressurised liquid supply control valve as described in any one of the three immediately preceding paragraphs wherein the sections of the operating weight element are connectable to the opening means in line by a single non-rigid line element.

According to a fifth embodiment of this invention there is provided a pressurised liquid supply control valve as described in any one of the four immediately preceding paragraphs wherein the operating weight element has a specific gravity in the range of substantially 1.1 to 1.7.

According to a sixth embodiment of this invention there is provided a pressurised liquid supply control valve as described in any one of the five immediately preceding paragraphs wherein the valve includes an inlet pressure operated flexible member adapted to control fluid passage from an inlet, through the valve to an outlet, an inlet connected chamber within the valve, a restricted passage formed through an element mounted to an housing of the valve to extend between the inlet, the inlet connected chamber and to atmosphere via an opening in the valve housing, a dynamic valve member, adapted to be operated by the action of the operating weight element, and mounted to control fluid passage through the restricted passage by, in a first mode venting the inlet connected chamber to atmosphere allowing the flexible member to displace under pressure at the inlet to open the valve and in a second mode closing the vent to atmosphere allowing the inlet pressure to reinstate the flexible member to close the valve.

According to a seventh embodiment of this invention there is provided a liquid storage tank having an outlet adjacent a lower point thereof and with first and second liquid inlets with one of inlets controlled by a valve as described in any one of the six immediately preceding paragraphs.

### BRIEF DESCRIPTION OF THE DRAWINGS

FIG. 1 is a cross-sectional view of the valve in an open mode, and

FIG. 2 is a cross-sectional view of the valve in a closed mode, and

FIG. 3 is an enlarged cross-sectional view of the central section of FIG. 2.

FIG. 4 is a partly schematic view depicting a typical installation utilising the valve.

In a preferred embodiment a valve 1 suitable for controlling a pressurised water supply 2 to a rainwater storage tank 3 is described. In a typical installation the valve 1 is preferably mounted adjacent to the top of the tank 3 above an overflow 6 to limit cross-contamination of the water supplies. The primary water supply to the tank 3 is rainwater, collected in known manner such as on an adjacent roof (not depicted) and fed to the tank such as via inlet 4. Preferably the tank 3 has an outlet 5 adjacently upward of the bottom thereof to gravity feed required apparatus such as toilets, baths and taps. As described in more detail below, the valve 1 includes a two section 7a and 7b operating weight element 7 suspended from an opening lever 12 of the valve 1 into the tank 3 via a depending connecting member 8.

Valve 1 preferably comprises an housing of two parts, 1a and 1b typically made of a suitable plastics material. The housing parts 1a and 1b are preferably assembled together by inter-engaging screw-threads 10 enabling access to an interior of the valve 1. Within the valve 1 a flexible member preferably in the nature of a diaphragm 14 is mounted to control the passage of water therethrough. Preferably the diaphragm 14 is fixed about its periphery between the housing parts 1a and 1b when joined as aforesaid. The diaphragm 14 closes against annular shaped valve seat 18 formed at the inner end of inlet 2b to separate the inlet 2b from the outlet 11. The diaphragm 14 also forms a chamber 20 within the valve 1 to the rear of and separated from the valve seat 18. As chamber 20 is separated from the valve seat 18 it is also separated from the outlet 11 and the inlet 2b. However, a restricted or bleed passage 16 is provided to conjoin the inlet 2b to the chamber 20 to provide for closing of the valve 1. In alternating sequence with the closing action, the restricted passage 16 also vents the chamber 20 to atmosphere enabling opening of the valve 1.

To that end, an aperture 15 is provided through the centre of the diaphragm 14 to sealingly accommodate a stem member 17 having a longitudinally bore 16b therethrough. The section of the stem 17 passing through the diaphragm 14 is of a reduced diameter to the remainder of the stem 17. Stem member 17 is mounted by its larger diameter end section between an annular skirt 21 and a spigot 25 formed internally of housing part 1b in axial alignment with aperture 15 in diaphragm 1. The sections of the bore 16b associated with these stem 17 sections are also of commensurately different diameters. An annular shoulder is formed at the junction of the stem 17 sections in which branches 16a of the bore 16b are formed to conjoin with the chamber 20. Within the enlarged diameter part of the bore 16a, adjacent to both sides of the junctions thereof with the bore branches 16a, ‘O-ring’ seals 24 are mounted. The seals 24 seal against a dynamic valve member, being rod 23, connected to support lever 12 and mounted within the bore 16b. An aperture 22 is formed through the wall of housing part 1b to accommodate rod 23 and form a vent to the bore 16b The bore 16b, 16a together with rod 23 and the vent aperture 22 form the restricted passage 16, the operation thereof being described in more detail below.

Rod 23 is mounted in the bore of stem 17 thereby reducing the volume thereof and projects through aperture 22 to be coupled to support lever 12. The raising and lowering of lever 12 reciprocally slides rod 23 within the bore 16a to control the passage of “bleed water” therethrough and open and close the valve. Rod 23 extends for the full length of the bore 16b and includes two longitudinally spaced apart annular grooves being an inlet bleed groove 26a and a venting groove 26b. The spacing apart of grooves 26a, 26b along rod 23 matches the spacing apart of ‘O-ring’ seals 24a and 24b.

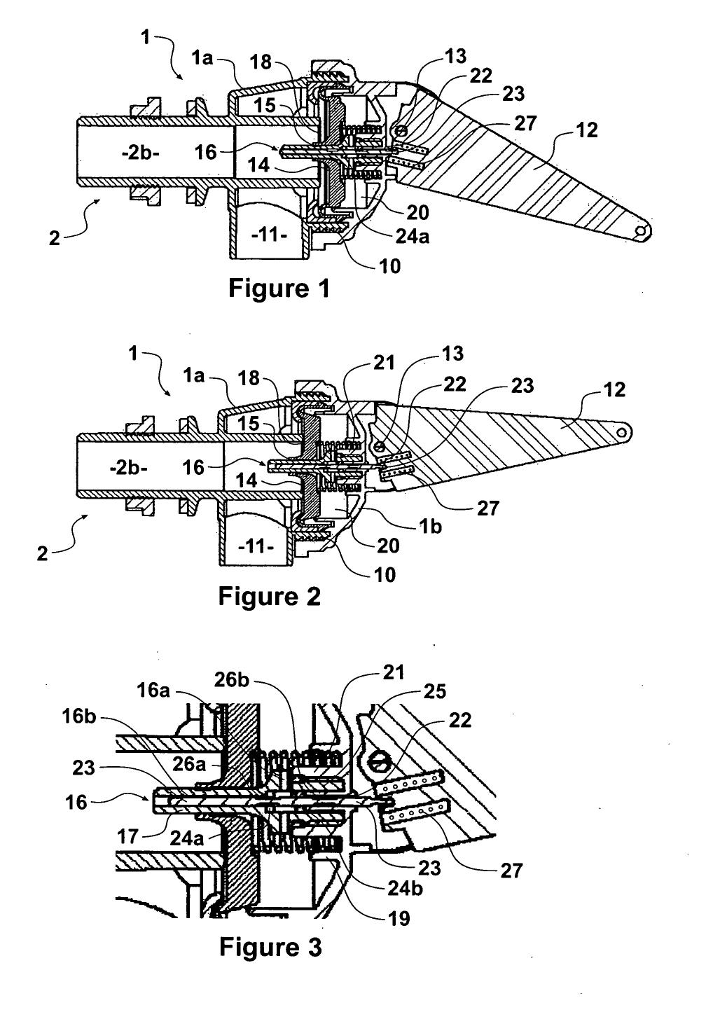

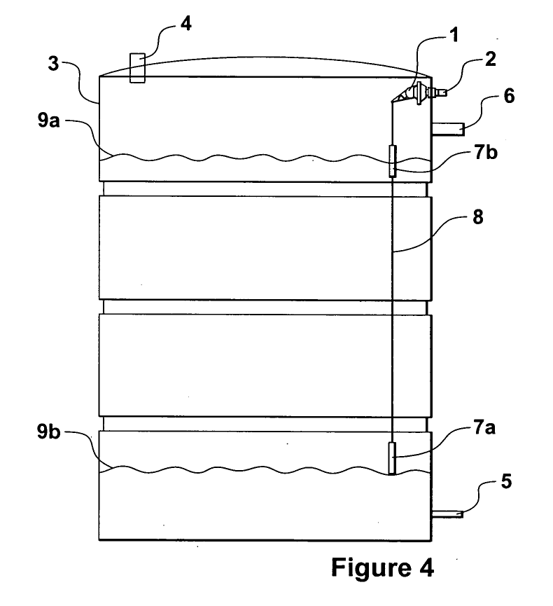

Referring in particular to in FIG. 1, the valve 1 is biased closed preferably by a compression spring 27 biasing the weight support level 12 upwardly about pivot point 13. In this closed/closing mode inlet bleed groove 26a straddles ‘O-ring’ seal 24a and “O-ring” seal 24b seals-off the chamber 11 from the vent aperture 22. Thus, water can bleed from inlet 2b into the chamber 11 resulting in an equalising of the pressures on each side of the diaphragm 14. This together with the action of compression spring 19 forces the diaphragm 14 against the valve seat 18 closing the valve 1. To ensure closure the surface area of the face of diaphragm 14 associated with chamber 20 is made greater than the surface area of the face thereof associated with the inlet 2b.

Referring now in particular to FIGS. 2 and 3. The two sections 7a and 7b operating weight 7 are preferably connected to the support lever 12 by a single non-rigid element such as a length of suitable cord 8. As will become apparent from the following description the weight sections 7a and 7b could be individually suspended by separate depending elements 8. However, it is envisaged this would be but a more complicated way of achieving the same end. In situ, the operating weight sections 7a and 7b are suspended on cord 8 one above the other from the support lever 12 into the tank 3 such that they come into contact with water charged thereinto.

The combined weight of the two operating weight sections 7a and 7b (the operating weigh 7) is such as to provide that the buoyancy therefore is marginally less than neutral buoyancy in water. If other liquids are involved then the combined weight is selected to provide for a corresponding buoyancy therein. In the preferred embodiment the operating weight 7 has a specific gravity in the range of substantially 1.1 to 1.7. With installation of the valve 1 the length of cord 8 from the support lever 12 to the lower weight section 7b is set to provide the minimum lower water level threshold indicated by water level line 9b within the tank 3. Also the height of weight section 7a above weight section 7b or in other words the length of cord 8 between the two weight sections 7a and 7b is set to provide the upper required and maximum water lever threshold indicated by water level line 9a

In operation, and assuming the quantity of water within the tank is above the required minimum water threshold level 9b. The operating weight 7 is only partly supported by the water, that is, weight section 7b is within and supported by the water but upper weight section 7b is clear and still solely supported by lever 12. The extent of biasing provided by spring 27 on operating lever 12 is selected such that in this closed mode the effective weight of the operating weight section 7b is insufficient to overcome the bias and open the valve 1. Should the water level drop below the required minimum threshold level 9b the operating weight 7 becomes fully supported by the support lever 12 and overcomes the biasing close force of spring 27 causing the support lever 12 to pivot downwardly and open the valve 1.

More particularly, with lowering of the weight support lever 12 rod 27 is inserted along bore 16a toward inlet 2b. This positions the venting groove 26b to straddle the associated seal 24b and thus vent, via aperture 22 the chamber 20 to atmosphere. Simultaneously the bleed groove 26a is positioned clear of the associated seal 24a and this closes the restrictive passage 16 between inlet 2b and chamber 20 and removes the equalising pressure therebetween. The pressure in the inlet 2b displaces the diaphragm 14 to inwardly of the chamber 14 to open the valve by joining the inlet 2b to the outlet 11. As the required minimum water level threshold 9a is reached the operating weight 7, that is the combined weight of the two weight sections 7a and 7b becomes buoyed up and substantially supported by the water. The weight element 7 thus becomes less effective and eventually the biasing of the weight support lever 12 will tend to withdraw rod 23 re-establishing the closed/closing mode described above.

1. A pressurised liquid supply control valve for a liquid storage tank comprising means to bias the valve to a closed mode and opening means to open the valve to an open mode characterised in that the opening means includes a two section operating weight element that combined have marginally less than neutral buoyancy in the liquid to be stored in the tank, the sections of the operating weight element being connectable individually or in line by a depending element(s) from the opening means such that one section is spaced above the other section and as to become in contact with a quantity of liquid therein, whereby the valve will open when the combined weight of the operating weight element sections results in an opening moment of force on the opening means and will close when the combined weight of the operating weight element sections is substantially supported by the liquid in the tank.

2. A pressurised liquid supply control valve as claimed in claim 1 wherein the valve is adapted to be mounted in situ within an upper section of a liquid storage tank and the length of the connection means between the opening means and the upper weight section of the weight element is selected to determine an upper level for the liquid within the tank and the length of the connection means between the opening means and the lower weight section of the weight element is selected to determine a lower level for the liquid within the tank.

3. A pressurised liquid supply control valve to control a pressurised liquid inlet to a tank for storing a quantity of the liquid and having a controllable outlet comprising means to bias the valve to a closed mode and opening means to open the valve to an open mode characterised in that the opening means includes a two section weight element with the sections adapted to be effectively separated one above the other at a distance to provide a required lower liquid level and an upper liquid level within the tank, the weight sections having a combined valve opening effective weight marginally less than that required to provide the weight element with a neutral buoyancy in the liquid; the weight element being connectable to the opening means whereby, in situ, with the valve mounted in an upper section of the tank and with the weight element suspended from the valve opening means into the tank, in a first operational mode the valve will be biased close until the level of liquid lowers to the required lower liquid level, that level being determined when both sections of the weight element become fully supported by the opening means thereby causing the valve to open and, in a second operational mode, upon the level of liquid increasing to the required upper liquid level, being a level at a height spaced above the required lower liquid level that is commensurate to the separation distance between the two weight sections and at which the liquid within the tank substantially supports both sections of the weight element, the biasing can operate to close the valve.

4. A pressurised liquid supply control valve as claimed in claim 1 wherein the sections of the operating weight element are connectable to the opening means in line by a single non-rigid line element.

5. A pressurised liquid supply control valve as described in claim 1 wherein the operating weight element has a specific gravity in the range of substantially 1.1 to 1.7.

6. A pressurised liquid supply control valve as claimed in claim 1 wherein the valve includes an inlet pressure operated flexible member adapted to control fluid passage from an inlet, through the valve to an outlet, an inlet connected chamber within the valve, a restricted passage formed through an element mounted to an housing of the valve to extend between the inlet, the inlet connected chamber and to atmosphere via an opening in the valve housing, a dynamic valve member, adapted to be operated by the action of the operating weight element, and mounted to control fluid passage through the restricted passage by, in a first mode venting the inlet connected chamber to atmosphere allowing the flexible member to displace under pressure at the inlet to open the valve and in a second mode closing the vent to atmosphere allowing the inlet pressure to reinstate the flexible member to close the valve.

7. A liquid storage tank having an outlet adjacent a lower point thereof and with first and second liquid inlets with one of inlets controlled by a valve as claimed in claim 1.

8. (canceled)

9. A pressurised liquid supply control valve as claimed in claim 2 wherein the sections of the operating weight element are connectable to the opening means in line by a single non-rigid line element.

10. A pressurised liquid supply control valve as described in claim 2 wherein the operating weight element has a specific gravity in the range of substantially 1.1 to 1.7.

11. A pressurised liquid supply control valve as claimed in claim 2 wherein the valve includes an inlet pressure operated flexible member adapted to control fluid passage from an inlet, through the valve to an outlet, an inlet connected chamber within the valve, a restricted passage formed through an element mounted to an housing of the valve to extend between the inlet, the inlet connected chamber and to atmosphere via an opening in the valve housing, a dynamic valve member, adapted to be operated by the action of the operating weight element, and mounted to control fluid passage through the restricted passage by, in a first mode venting the inlet connected chamber to atmosphere allowing the flexible member to displace under pressure at the inlet to open the valve and in a second mode closing the vent to atmosphere allowing the inlet pressure to reinstate the flexible member to close the valve.

12. A liquid storage tank having an outlet adjacent a lower point thereof and with first and second liquid inlets with one of inlets controlled by a valve as claimed in claim 2.

13. A pressurised liquid supply control valve as claimed in claim 3 wherein the sections of the operating weight element are connectable to the opening means in line by a single non-rigid line element.

14. A pressurised liquid supply control valve as described in claim 3 wherein the operating weight element has a specific gravity in the range of substantially 1.1 to 1.7.

15. A pressurised liquid supply control valve as claimed in claim 3 wherein the valve includes an inlet pressure operated flexible member adapted to control fluid passage from an inlet, through the valve to an outlet, an inlet connected chamber within the valve, a restricted passage formed through an element mounted to an housing of the valve to extend between the inlet, the inlet connected chamber and to atmosphere via an opening in the valve housing, a dynamic valve member, adapted to be operated by the action of the operating weight element, and mounted to control fluid passage through the restricted passage by, in a first mode venting the inlet connected chamber to atmosphere allowing the flexible member to displace under pressure at the inlet to open the valve and in a second mode closing the vent to atmosphere allowing the inlet pressure to reinstate the flexible member to close the valve.

16. A liquid storage tank having an outlet adjacent a lower point thereof and with first and second liquid inlets with one of inlets controlled by a valve as claimed in claim 3.
